(19) United States
(12) Patent Application Publication
(10) Pub. No.: US 2025/0015522 A1
(43) Pub. Date: Jan. 9, 2025

(54) CONNECTOR AND CONNECTOR DEVICE

(71) Applicant: I-PEX Inc., Kyoto-shi (JP)

(72) Inventor: Shuta YAMAGUCHI, Ogori-city (JP)

(21) Appl. No.: 18/895,565

(22) Filed: Sep. 25, 2024

Related U.S. Application Data
(63) Continuation of application No. PCT/JP2023/012032, filed on Mar. 24, 2023.

(30) Foreign Application Priority Data
Mar. 28, 2022 (JP) 2022-051423

(51) Int. Cl. H01R 12/71; H01R 12/70; H01R 12/75; H01R 13/631; H01R 13/6582; H01R 13/6585; H01R 13/6594

(52) U.S. Cl. CPC H01R 12/716; H01R 12/707; H01R 12/75; H01R 13/631; H01R 13/6582; H01R 13/6585; H01R 13/6594

(57) ABSTRACT

A connector may include: an insulating housing including a facing surface configured to face a circuit board; a conductive first contact including a first connecting portion extending from the housing toward one direction along a parallel orientation that is parallel to the facing surface, the first contact configured to be electrically connected to the circuit board; a conductive second contact including a second connecting portion extending from the housing toward an opposite direction of the one direction, the second contact configured to be electrically connected to the circuit board; and a conductive shell covering at least a part of the housing, wherein the shell includes: a first shield portion surrounding the first connecting portion when viewed from a perpendicular orientation that is perpendicular to the facing surface; and a second shield portion surrounding the second connecting portion when viewed from the perpendicular orientation.

### CROSS-REFERENCE TO RELATED APPLICATIONS

This application is a continuation application of PCT Application No. PCT/JP2023/012032, filed on Mar. 24, 2023, which claims the benefit of priority from Japanese Patent Application No. 2022-051423, filed on Mar. 28, 2022. The entire contents of the above listed PCT and priority applications are incorporated herein by reference.

### BACKGROUND

### Field

The present disclosure relates to a connector and a connector device.

### Description of the Related Art

Japanese Unexamined Patent Publication No. 2019-87462 discloses a configuration in which a board side connector includes a plurality of first board side contacts arranged side by side in the left-right orientation at a predetermined arrangement pitch on one of the front and rear sides of a board side housing, and a plurality of second board side contacts arranged side by side in the left-right orientation at the same arrangement pitch on the other of the front and rear sides of the board side housing at positions shifted in the left-right orientation by half the arrangement pitch with respect to the first board side contacts.

### SUMMARY

Disclosed herein is a connector configured to be mounted on a circuit board and to fit to a mate connector. The connector may include: an insulating housing including a facing surface configured to face the circuit board; a conductive first contact including a first connecting portion extending from the housing toward one direction along a parallel orientation that is parallel to the facing surface, the first contact configured to be electrically connected to the circuit board; a conductive second contact including a second connecting portion extending from the housing toward an opposite direction of the one direction, the second contact configured to be electrically connected to the circuit board; and a conductive shell covering at least a part of the housing, wherein the shell includes: a first shield portion surrounding the first connecting portion when viewed from a perpendicular orientation that is perpendicular to the facing surface; and a second shield portion surrounding the second connecting portion when viewed from the perpendicular orientation.

Additionally, a connector configured to be mounted on a circuit board and to fit to a mate connector is disclosed herein. The connector may include: an insulating housing including a facing surface configured to face the circuit board while the connector is mounted on the circuit board; a conductive contact including a connecting portion extending from the housing toward one direction along the facing surface, the contact configured to be electrically connected to the circuit board; and a conductive shell surrounding the housing and the connecting portion around a first orientation that is perpendicular to the circuit board, wherein the mate connector comprises: an insulating mate housing configured to fit to the housing; a conductive mate contact held by the mate housing, the mate contact configured to be connected to an inner conductor of a cable, and to be in contact with the contact; and a conductive mate shell covering at least a part of the mate housing, wherein the mate shell includes: a mate fitting portion configured to fit to the shell along the first orientation; and a surrounding portion adjacent to the mate fitting portion along a second orientation that is perpendicular to the first orientation, the surrounding portion configured to surround an end portion of the cable around the second orientation to be electrically connected to an outer conductor of the cable, and wherein the shell comprises: a fitting portion configured to fit to the mate fitting portion; an extending portion extending from the fitting portion along the facing surface to be located between the circuit board and the surrounding portion, the extending portion configured to be electrically connected to the circuit board, and wherein the extending portion is further configured to be in contact with the surrounding portion while the mate fitting portion fits to the fitting portion.

### BRIEF DESCRIPTION OF THE DRAWINGS

FIG. 1 is a perspective view of an example connector device.

FIG. 2 is a perspective view of an example receptacle connector.

FIG. 3A is a top view of the receptacle connector, and FIG. 3B is a bottom view of the receptacle connector.

FIG. 4A is a side view of the receptacle connector, and FIG. 4B and FIG. 4C are views taken along arrows IVb-IVb and IVc-IVc in FIG. 3A, respectively.

FIG. 5A is a perspective view of an example plug connector, and FIG. 5B is a top view of the plug connector.

FIG. 6A is a perspective view of the plug connector, and FIG. 6B is a bottom view of the plug connector.

FIG. 7A, FIG. 7B, and FIG. 7C are diagrams for explaining a fitting state in the connector device, and are diagrams corresponding to FIG. 4A, FIG. 4B, and FIG. 4C.

### DETAILED DESCRIPTION

In the following description, with reference to the drawings, the same reference numbers are assigned to the same components or to similar components having the same function, and overlapping description is omitted.

In the board side connector described in Japanese Unexamined Patent Publication No. 2019-87462, in the first board side contact and the second board side contact, a connecting portion used for connection with a trace of the board is exposed. Accordingly, noise may be generated at the time of signal transmission.

The present disclosure has been made in view of the above, and the present disclosure is for providing a technique capable of preventing generation of noise during signal transmission.

A connector according to an aspect of the present disclosure is a connector mounted on a board and capable of fitting to a mate connector. The connector includes: a housing facing the board; a conductive first contact including a first connecting portion extending from one side of the housing and connected to the board, a conductive second contact including a second connecting portion extending from another side of the housing and connected to the board, and a conductive shell covering at least a part of the housing. The shell includes a first shield portion surrounding the first connecting portion and a second shield portion surrounding the second connecting portion.

According to the above connector, the periphery of the first connecting portion of the first contact is covered by the first shield portion, and the periphery of the second connecting portion of the second contact is covered by the second shield portion. Accordingly, generation of noise from the first connecting portion and the second connecting portion during signal transmission can be suppressed.

The second shield portion may include a shell connecting portion configured to be electrically connected to the board while mounted.

By providing the shell connecting portion, the electrical connection between the shell and the board can be made more reliably, and the shielding property can be enhanced.

The second shield portion may include a contacting protrusion configured to be in contact with a shell of the mate connector while fitting to the mate connector.

With the above configuration, the shell and the shell of the mate connector can be more reliably connected to each other by the contacting protrusion, so that the shielding property at the time of fitting can be enhanced.

The shell may include an engaging portion configured to engage with the mate connector between the first shield portion and the contacting protrusion when viewed from a side of the housing.

Since the contacting protrusion is provided, a force acts in a direction of fitting with the mate connector. On the other hand, by providing the engaging portion, the fitting state with the mate connector may be maintained.

The first contact may include a first contacting portion configured to be in contact with the contact of the mate connector, the second contact may include a second contacting portion configured to be in contact with the contact of the mate connector, and the shell may include an engaging portion configured to engage with the mate connector between the first contacting portion and the second contacting portion, and the contacting protrusion when viewed from a side of the housing.

Since the contacting protrusion is provided, a force acts in a direction of fitting with the mate connector. On the other hand, by providing the engaging portion, the fitting state with the mate connector may be maintained. In particular, by providing the engaging portion between the first contacting portion and the second contacting portion, and the contacting protrusion, the contact point with the mate connector may be prevented from being affected by the force in the direction of fitting with the mate connector, which is generated by providing the contacting protrusion.

A connector device according to another aspect of the present disclosure is a connector device including: a receptacle connector mounted on a board and a plug connector connected to a plurality of cables and configured to be fitted to the receptacle connector. The receptacle connector includes: a housing facing the board; a conductive first contact including a first connecting portion extending from one side of the housing and connected to the board; a conductive second contact including a second connecting portion extending from the other side of the housing and connected to the board; and a conductive shell covering at least a part of the housing. The shell includes a first shield portion surrounding the first connecting portion and a second shield portion surrounding the second connecting portion. The plug connector includes: a plug housing, a plurality of conductive plug contacts configured to individually contact either the first contact or the second contact of the receptacle connector; and a conductive plug shell covering at least a part of the plug housing. The plug shell is configured to be in contact with the second shield portion while fitting.

According to the above connector device, in the receptacle connector, the periphery of the first connecting portion of the first contact is covered by the first shield portion, and the periphery of the second connecting portion of the second contact is covered by the second shield portion. Accordingly, generation of noise from the first connecting portion and the second connecting portion during signal transmission can be suppressed. On the other hand, by the plug shell of the plug connector contacting the second shield portion, the plug shell also functions as a shield. Accordingly, generation of noise from the first connecting portion and the second connecting portion during signal transmission can be suppressed.

The shell of the receptacle connector may include an engaging portion configured to engage with the plug connector, and the plug shell may include an mating portion configured to engage with the engaging portion.

With the above configuration, the fitting state between the receptacle connector and the plug connector may more firmly be maintained.

The mating portion may be provided on each of a pair of side surfaces of the plug shell facing each other in an orientation in which the plurality of plug contacts are arranged.

Since the engaging portions are provided on both of the pair of side surfaces of the plug shell, the fitting state between the receptacle connector and the plug connector may more firmly be maintained.

A connector according to another aspect of the present disclosure is a connector mounted on a board and capable of fitting to a mate connector. The connector includes: a housing facing the board; a conductive contact including a connecting portion extending from one side of the housing and connected to the board; and a conductive shell surrounding the housing and the connecting portion around a first orientation perpendicular to the board. The mate connector includes: a mate housing configured to fit to the housing; a mate contact held by the mate housing, connected to an inner conductor of a cable, and configured to be in contact with the contact; and a conductive mate shell covering at least a part of the mate housing. The mate shell includes: a fitting portion configured to fit to the shell; and a surrounding portion surrounding an end portion of the cable around a second orientation parallel to the board and connected to an outer conductor of the cable at a position adjacent to the housing along the second orientation. The shell includes an extending portion extending along the board, configured to be located between the board and the surrounding portion, connected to the board, and configured to be in contact with the surrounding portion.

A connector device according to another aspect of the present disclosure includes: a connector mounted on a board; and a mate connector connected to a cable and configured to fit to the connector. The connector includes: a housing facing the board; a conductive contact including a connecting portion extending from one side of the housing and connected to the board; and a conductive shell surrounding the housing and the connecting portion around a first orientation perpendicular to the board. The mate connector includes: a mate housing configured to fit to the housing; a mate contact held by the mate housing, connected to an inner conductor of the cable, and in contact with the contact; and a conductive mate shell covering at least a part of the mate housing. The mate shell includes: a fitting portion fitted to the shell; and a surrounding portion surrounding an end portion of the cable around a second orientation parallel to the board and connected to an outer conductor of the cable at a position adjacent to the housing along the second orientation. The shell includes an extending portion extending along the board, configured to be located between the board and the surrounding portion, connected to the board, and configured to be in contact with the surrounding portion.

According to the present disclosure, there is provided a technique capable of preventing generation of noise during signal transmission.

### Outline of Connector Device

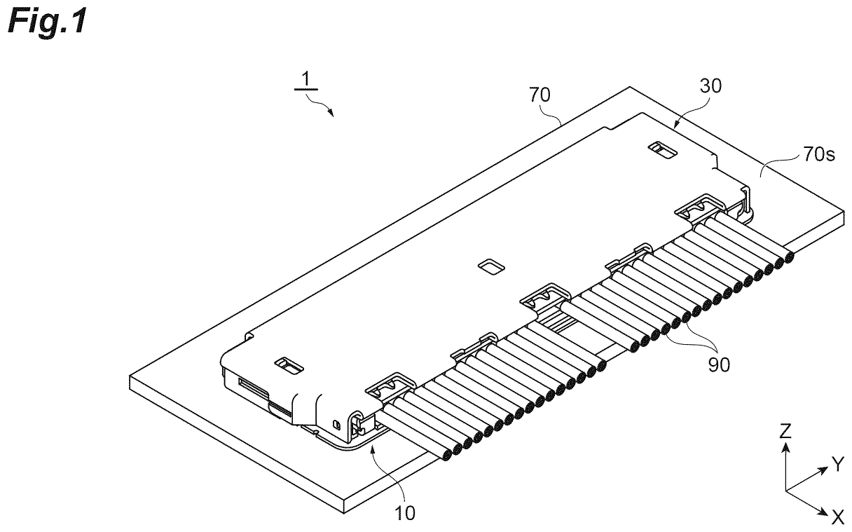

An overview of the connector device will be described with reference to FIG. 1. As illustrated in FIG. 1, a connector device 1, which is a kind of electrical connector, includes a receptacle connector 10 and a plug connector 30 (mate connector).

The receptacle connector 10 is mounted on a circuit board 70 and electrically connected to the circuit board 70. The plug connector 30 is attached to an electrical cable 90 and electrically connected to the electrical cable 90.

The receptacle connector 10 and the plug connector 30 are configured to be fitted to and removed from each other along a perpendicular orientation that is perpendicular to a main surface 70s of the circuit board 70. In a fitting state of the receptacle connector 10 and the plug connector 30, a conductive path (for example, wiring, and not illustrated.) formed in the main surface 70s of the circuit board 70 and the electrical cable 90 are electrically connected. In this way, the connector device 1 is a device for electrically and physically connecting the conductive path and the electrical cable.

The circuit board 70 is any type of board on which electronic circuits and electronic components are mounted, and is, for example, a printed board or a flexible printed board. The circuit board 70 is mounted with the receptacle connector 10 on the main surface 70s by solder connection or the like.

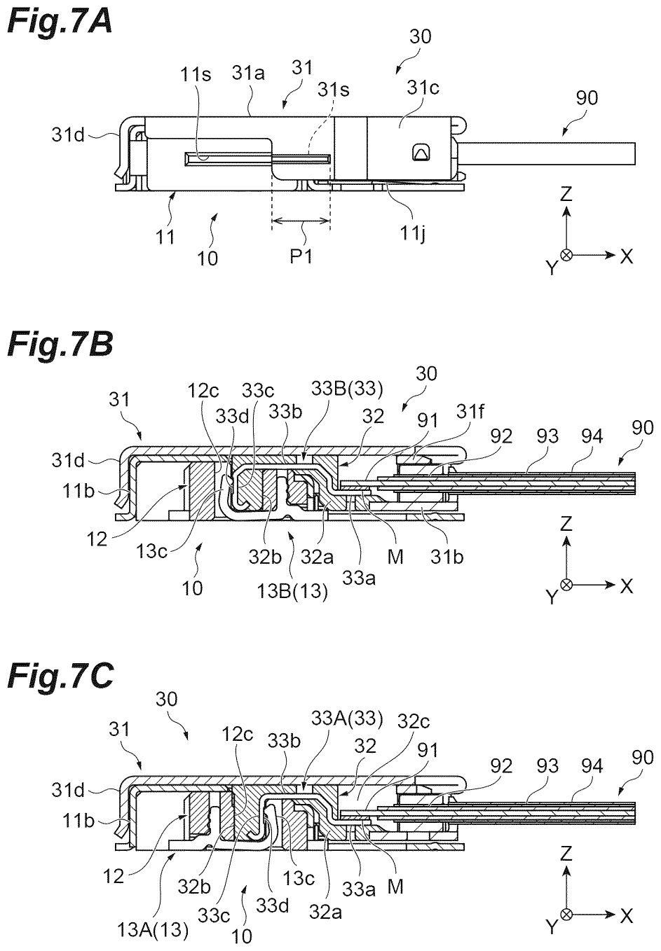

The electrical cable 90 is a wiring used for transmitting signals and the like between various circuit boards incorporated in small electronic devices such as cellular phones, and is, for example, a coaxial cable or the like. The electrical cable 90 extends along a parallel orientation that is parallel to the circuit board 70 in the fitting state of the receptacle connector 10 and the plug connector 30. The plug connector 30 may be a connector for a coaxial cable extending along the parallel orientation. The electrical cable 90 includes an inner conductor 91 made of a metallic wire (for example, a copper wire) extending linearly, an insulator 92 covering the circumferential surface of the inner conductor 91, an outer conductor 93 made of a metallic braided wire having a cylindrical shape and covering the circumferential surface of the insulator 92, and a protective sheath 94 on the circumferential surface of the outer conductor 93 (see FIG. 7B and FIG. 7C).

In the following, X-axis orientation corresponds to the parallel orientation (a second orientation), and Z-axis orientation corresponds to the perpendicular orientation (a first orientation).

### Receptacle Connector

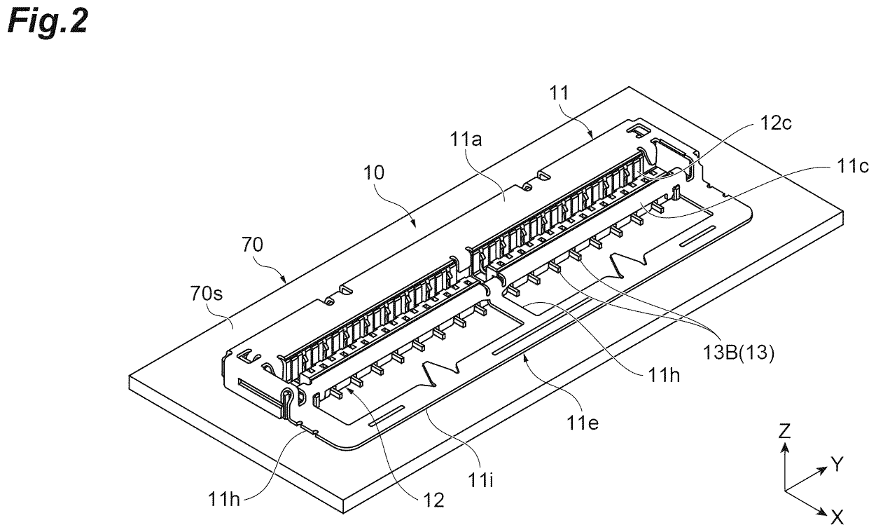

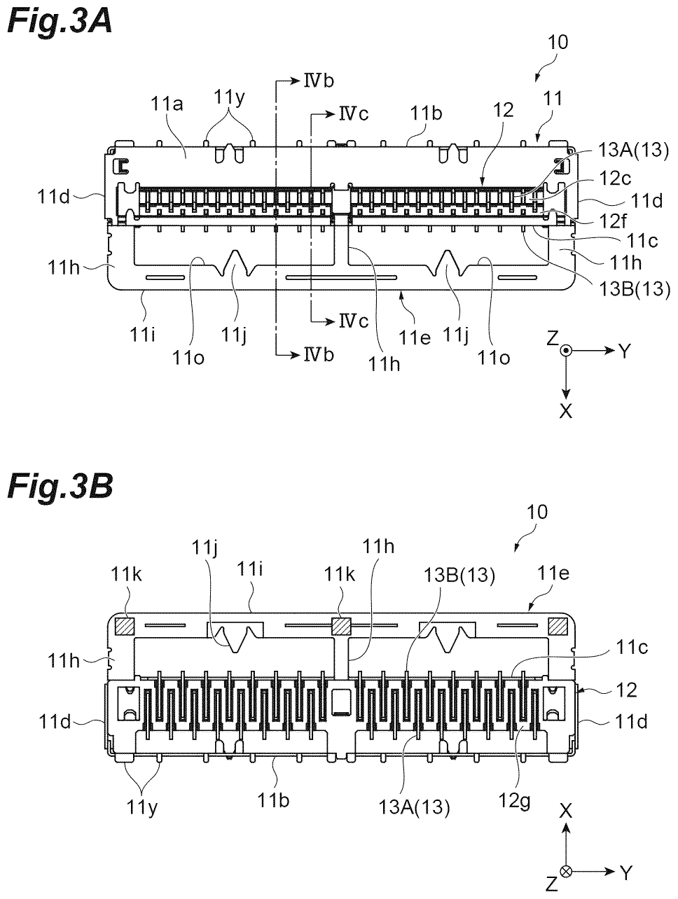

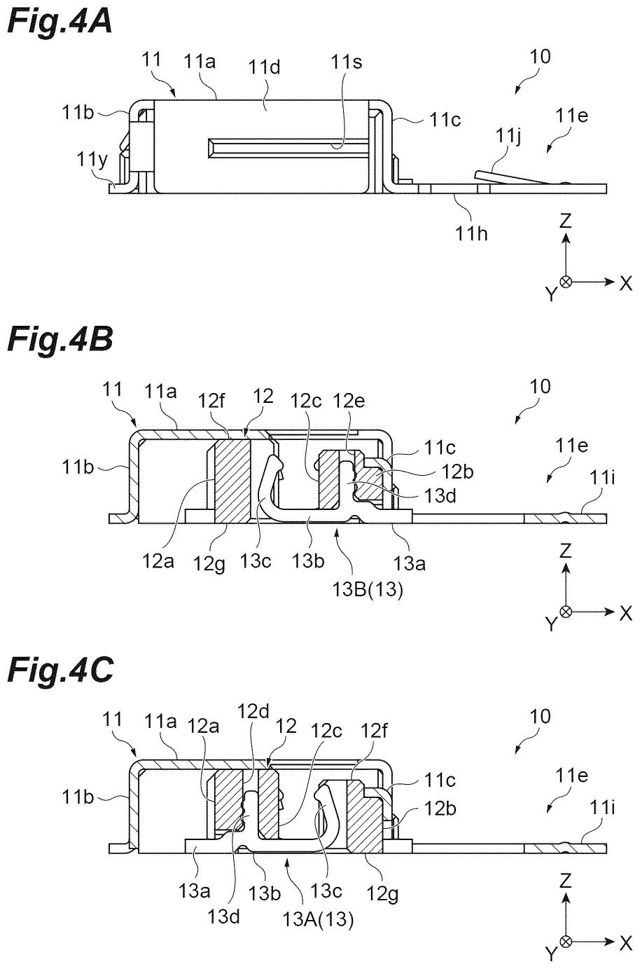

The receptacle connector 10 will be described with reference to FIG. 2, FIG. 3A, FIG. 3B, FIG. 4A, FIG. 4B, and FIG. 4C. The receptacle connector 10 is an elongated connector having a main body portion extending along Y-axis orientation that is perpendicular to both the X-axis orientation and the Z-axis orientation, and is mounted on the main surface 70s of the circuit board 70 (see FIGS. 1 and 2). Although FIG. 4B and FIG. 4C respectively show a view taken along arrows IVb-IVb and a view taken along arrows IVc-IVc illustrated in FIG. 3A, some members (contacting protrusions) are not illustrated.

As illustrated in FIG. 2, FIG. 3A, FIG. 3B, and the like, the receptacle connector 10 includes a shell 11, a housing 12 facing the circuit board 70, and contacts 13 that are a plurality of contacts. The plurality of contacts 13 are configured to include a plurality of first contacts 13A and a plurality of second contacts 13B.

The housing 12 is made of a resin-containing insulating material and holds a plurality of contacts 13 arranged along the Y-axis orientation (arrangement orientation). The housing 12 is interposed between the shell 11 and the contacts 13 to insulate them from each other. As illustrated in FIG. 4B and FIG. 4C, the housing 12 is covered with the shell 11 and holds the contacts 13 so that both ends of the contacts 13 are exposed.

For example, the housing 12 includes side walls 12a, 12b. Each of the side walls 12a, 12b is a side surface extending in the Y-axis orientation along the long sides of the housing 12. As illustrated in FIG. 4C, one end of the first contact 13A of the plurality of contacts 13 protrudes from the side wall 12a in the X-axis orientation. Further, as illustrated in FIG. 4B, one end of the second contact 13B protrudes from the side wall 12b in the X-axis orientation.

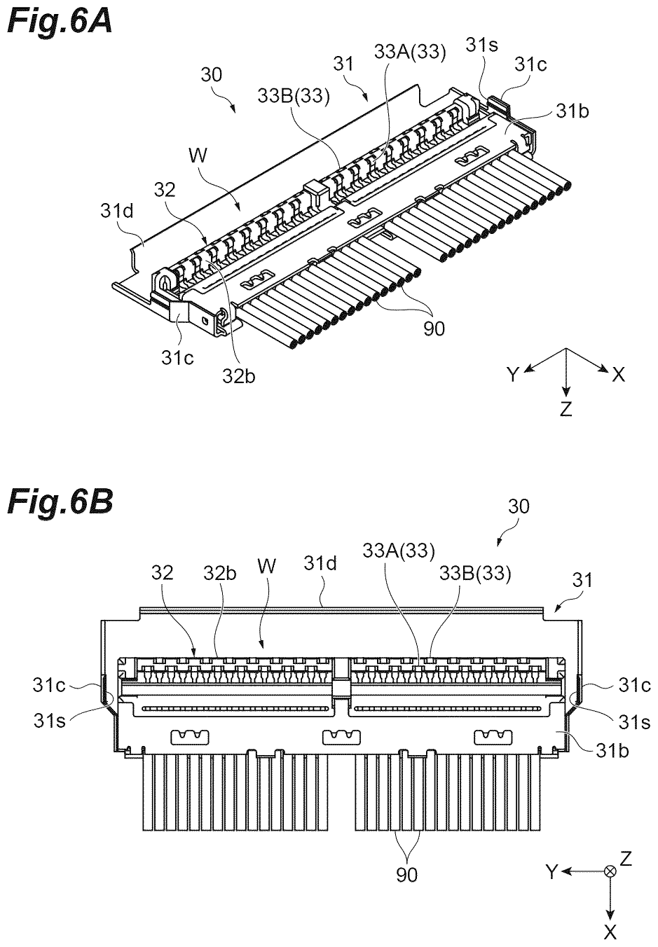

As illustrated in FIG. 4A, FIG. 4B, and FIG. 4C, the housing 12 includes a depressed groove portion 12c extending in the Y-axis orientation so as to open the upper surface thereof. The groove portion 12c is a space for housing the plug connector 30. Inside the groove portion 12c, a ridge W of the plug connector 30 (see FIG. 6A) is housed. Inside the groove portion 12c, the other ends of the first contact 13A and the second contact 13B are exposed.

In addition, as illustrated in FIG. 4B, FIG. 4C, and the like, the housing 12 is provided with through holes 12d for supporting the first contacts 13A and through holes 12e for supporting the second contacts 13B. The through holes 12d and 12e are formed so as to correspond to the attachment positions of the contact 13.

A part of an upper surface 12f of the housing 12 is covered with the shell 11, but the remaining part of the upper surface 12f and a bottom surface 12g (a facing surface configured to face the circuit board 70) are exposed without being covered with the shell 11, as illustrated in FIG. 3A, FIG. 3B, and the like. A pair of side walls extending in the X-axis orientation other than the side walls 12a, 12b are covered by the shell 11.

The shell 11 is formed of, for example, a pressed metallic plate-shaped member, and is elastic and conductive. For example, as illustrated in FIG. 3A and FIG. 3B, the shell 11 includes an upper surface portion 11a, side walls 11b and 11c that are a pair of side walls extending along the Y-axis orientation, a pair of side walls 11d extending along the X-axis orientation, and an extending portion 11e, so as to substantially cover the housing 12.

The upper surface portion 11a extends along the XY plane so as to cover the upper surface 12f of the housing 12. In the vicinity of the center along the longitudinal orientation of the upper surface portion 11a, the upper surface portion 11a is formed so as to cover a surface of the upper surface 12f of the housing 12, which is far from the extending portion 11e with the groove portion 12c interposed therebetween, so that the ridge W of the plug connector 30 (see FIG. 6A and FIG. 6B) can be inserted into the groove portion 12c of the housing 12 from above.

As illustrated in FIGS. 3A, 3B, and the like, the side walls 11b, 11c are facing with each other in the X-axis orientation and extend along the Y-axis orientation. The side wall 11b is located outward of the side wall 12a of the housing 12 in the X-axis orientation. The side wall 11b extends upwardly from the main surface 70s of the circuit board 70. The side wall 11b and the upper surface portion 11a are continuous at one end of the side wall 11b in the Z-axis orientation.

The side wall 11b is provided with a plurality of protrusions 11y protruding outward (in a direction away from the housing 12) along the horizontal orientation (XY orientation). This protrusion 11y may be used for securing the shell 11 onto the main surface 70s of the circuit board 70. That is, the protrusion 11y can be fixed onto the main surface 70s by soldering or the like.

The side wall 11c is located outward of the side wall 12b of the housing 12 in the X-axis orientation. As illustrated in FIG. 4A, the side wall 11c extends upward from the main surface 70s of the circuit board 70 at both ends in the Y-axis orientation. On the other hand, as illustrated in FIG. 4B, FIG. 4C, and the like, at the center in the Y-axis orientation, the lower end of the side wall 11c (the end closer to the circuit board 70) is provided at a position away from the circuit board 70. From the space below the side wall 11c in the center (closer to the circuit board 70), the second contacts 13B protrude. Similarly, the upper end of the side wall 11c at the center in the Y-axis orientation is bent along the upper surface 12f of the housing 12. The side wall 11c and the upper surface portion 11a are continuous at both ends in the Y-axis orientation of the side wall 11c.

As illustrated in FIG. 3A, FIG. 3B, and the like, the pair of side walls 11d are facing with each other in the Y-axis orientation and extend along the X-axis orientation. Each of the pair of side walls 11d is provided so as to cover the side surfaces at both ends in the Y-axis orientation of the housing 12. Each of the pair of side walls 11d is connected to the upper surface portion 11a.

As illustrated in FIGS. 2 and 4A, each of the pair of side walls 11d is provided with a recess 11s extending horizontally (in the X-axis orientation). The recess 11s may function as an engaging portion used to engage with a shell 31 of the plug connector 30. This point will be described later.

As illustrated in FIGS. 2 and 3A, the extending portion 11e is provided so as to protrude outward (in a direction away from the housing 12) from the side wall 11c of the shell 11. The extending portion 11e is configured to include: three projecting portions 11h extending outward along the X-axis orientation from the lower ends at both ends of the side wall 11c in the Y-axis orientation and the lower end at the center: and a coupling portion 11i extending in the Y-axis orientation so as to connect the three projecting portions 11h. As illustrated in FIG. 4A, each of the three projecting portions 11h extends horizontally at approximately the same height as the main surface 70s of the circuit board 70. Further, the coupling portion 11i extends in the Y-axis orientation so as to connect the three projecting portions 11h to each other. As a result, two openings 110 surrounded by the side wall 11c and the extending portion 11e are formed in the shell 11.

The coupling portion 11i of the extending portion 11e is provided with contacting protrusions 11j that protrude towards the center of the opening 110. Two contacting protrusions 11j are provided so as to protrude from each of the two openings 110. As illustrated in FIG. 4A, each of the contacting protrusions 11j is inclined upward from the coupling portion 11i toward the center of the opening 110. The contacting protrusions 11j are provided to ensure a connection with the shell 31 of the plug connector 30 while the plug connector 30 is fitted to the receptacle connector 10.

As illustrated in FIG. 3B, a shell connecting portion 11k for electrical connection to the main surface 70s is provided on the lower surface of the coupling portion 11i of the extending portion 11e (a face to which the main surface 70s of the circuit board 70 faces). While the receptacle connector 10 is fixed to the circuit board 70, the shell connecting portion 11k is coated with solder and joined to the main surface 70s of the circuit board 70.

The contact 13 (the first contact 13A and the second contact 13B) is formed of, for example, a pressed metallic plate member, and is elastic and conductive. As illustrated in FIG. 4B, FIG. 4C, and the like, each contact 13 extends along the X-axis orientation and includes a connecting portion 13a, an intermediate portion 13b, and a contacting portion 13c. Further, the contact 13 includes a branching portion 13d that branches from the intermediate portion 13b and extends in the X-axis orientation. Although the first contact 13A and the second contact 13B have the same shape, the attachment positions in the receptacle connector 10 are different from each other. Accordingly, the first contact 13A and the second contact 13B will be individually described below also with regards to the attachment portions.

First, each part of the first contact 13A will be described. As illustrated in FIG. 4C, the connecting portion 13a (first connecting portion) of the first contact 13A is disposed on the main surface 70s of the circuit board 70 and connected to the conductive path of the circuit board 70, for example, by soldering. The connecting portion 13a is located between the side wall 11b of the shell 11 and the side wall 12a of the housing 12. Therefore, the side wall 11b of the shell 11 functions as a first shield portion which is disposed so as to surround the connecting portion 13a of the first contact 13A.

The intermediate portion 13b in the first contact 13A connects the connecting portion 13a and the contacting portion 13c. The intermediate portion 13b extends from the side wall 12a of the housing 12 into the groove portion 12c.

The branching portion 13d branching from the intermediate portion 13b extends upward and is inserted into the through hole 12d of the housing 12. The diameter of the through hole 12d corresponds to the outer diameter of the branching portion 13d so that the branching portion 13d is supported by the housing 12 in the through hole 12d. Thus, the first contact 13A is fixed to the housing 12.

The contacting portion 13c of the first contact 13A is the portion that protrudes into the groove portion 12c. As illustrated in FIG. 7C, the contacting portion 13c is in contact with a contact 33 of the plug connector 30 described later in the fitting state of the receptacle connector 10 and the plug connector 30. A tip portion of the contacting portion 13c is curved. The contacting portion 13c is configured to be elastically deformable.

Next, each part of the second contact 13B will be described. As illustrated in FIG. 4B, the connecting portion 13a (second connecting portion) of the second contact 13B is disposed on the main surface 70s of the circuit board 70 and connected to the conductive paths of the circuit board 70, for example, by solder. The connecting portion 13a is located between the coupling portion 11i of the extending portion 11e of the shell 11 and the side wall 12b of the housing 12. Therefore, the extending portion 11e of the shell 11 (particularly, the coupling portion 11i) functions as a second shield portion disposed so as to surround the connecting portion 13a in the second contact 13B.

The intermediate portion 13b of the second contact 13B connects the connecting portion 13a and the contacting portion 13c. The intermediate portion 13b extends from the side wall 12a of the housing 12 into the groove portion 12c.

The branching portion 13d branching from the intermediate portion 13b extends upward and is inserted into the through hole 12e of the housing 12. The diameter of the through hole 12e corresponds to the outer diameter of the branching portion 13d so that the branching portion 13d is supported by the housing 12 in the through hole 12e. Thus, the second contact 13B is fixed to the housing 12.

The contacting portion 13c of the second contact 13B is the portion that protrudes into the groove portion 12c. As illustrated in FIG. 7B, the contacting portion 13c is in contact with the contact 33 of the plug connector 30 described later in the fitting state of the receptacle connector 10 and the plug connector 30. A tip portion of the contacting portion 13c is curved. The contacting portion 13c is configured to be elastically deformable.

As illustrated in FIG. 2 and FIG. 3A, the first contacts 13A and the second contacts 13B are alternately arranged along the Y-axis orientation. Further, the first contacts 13A and the second contacts 13B are arranged in a row along the Y-axis orientation.

### Plug Connector

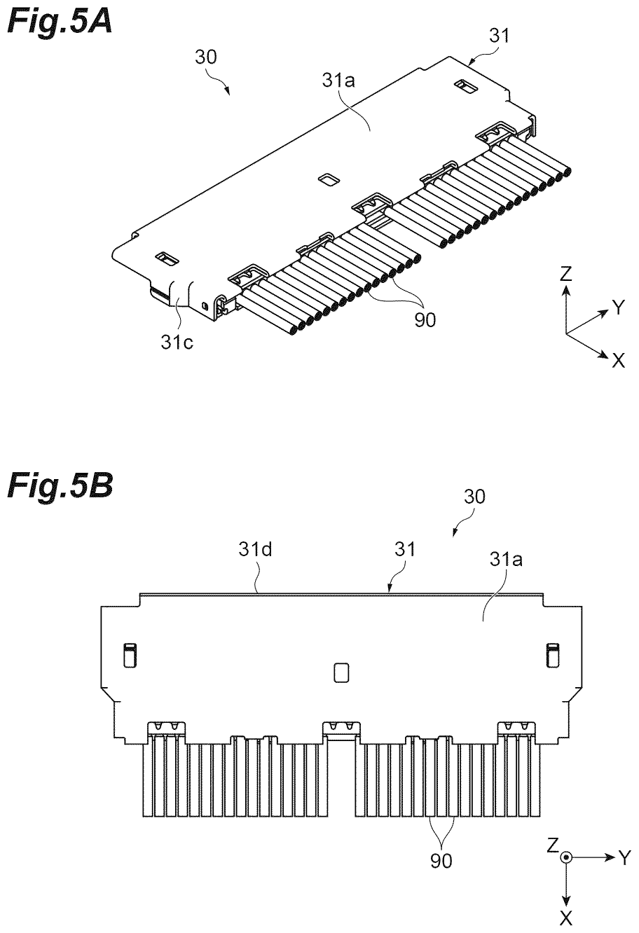

Next, the plug connector 30 will be described in detail with reference to FIG. 5A, FIG. 5B, FIG. 6A, FIG. 6B, FIG. 7B, and FIG. 7C. The plug connector 30 is an elongated connector in which a main body portion extends along the Y-axis orientation, is configured to be fitted to the receptacle connector 10 that is a mate connector, and is a connector in which a plurality of electrical cables 90 are connected. As illustrated in FIG. 5A, FIG. 5B, FIG. 6A, and FIG. 6B, the plug connector 30 includes the shell 31 (plug shell), a housing 32 (plug housing), and a plurality of contacts 33 (plug contacts). The plurality of contacts 33 are configured to include a plurality of first contacts 33A and a plurality of second contacts 33B.

The housing 32 is made of a resin-containing insulating material, holds a plurality of contacts 33, and insulates between the shell 31 and the contacts 33. As illustrated in FIGS. 7B and 7C, for example, the housing 32 includes a main body 32a and a tip portion 32b. The main body 32a extends along the Y-axis orientation. The main body 32a holds the contact 33 and includes, at one end along the X-axis orientation (one end connected to the electrical cable 90), a cutout 32c that exposes the tip of the contact 33 and is disposed in a state where the contact 33 and the tip of the electrical cable 90 are connected to each other.

The tip portion 32b protrudes in the Z-axis orientation from one end of the main body 32a (the end opposite to the end where the cutout 32c is provided). The tip portion 32b holds the contact 33 extending in the Z-axis orientation. Together with the contact 33, the tip portion 32b constitutes the ridge W of the plug connector 30. Therefore, the thickness of the tip portion 32b (dimension in the Z-axis orientation) corresponds to the height of the groove portion 12c of the receptacle connector 10 (dimension in the Z-axis orientation). As illustrated in FIG. 7B and FIG. 7C, in a state where the plug connector 30 is fitted to the receptacle connector 10, the contact 33 attached to the tip portion 32b and the contact 13 exposed from the groove portion 12c are brought into contact with each other, thereby constituting, for example, a part of a signal circuit.

The shell 31 is formed of, for example, a pressed metallic plate-shaped member, and is elastic and conductive. As illustrated in FIGS. 6A and 6B, for example, the shell 31 includes an upper wall 31a, a bottom wall 31b, side walls 31c, and a front wall 31d.

As illustrated in FIG. 5A and FIG. 5B, the upper wall 31a covers the tip portion of the electrical cable 90 and covers the upper surface of the housing 32. The upper wall 31a extends in the Y-axis orientation. Further, as illustrated in FIG. 7B and FIG. 7C, a cable support 31f extending from the upper wall 31a and folded back toward the circuit board 70 is provided.

As illustrated in FIG. 6A and FIG. 6B, the bottom wall 31b is provided so as to be continuous from the end of the main body 32a of the housing 32 where the cutout 32c is provided, and is provided below the tip of the electrical cable 90. The bottom wall 31b extends in the Y-axis orientation integrally with the housing 32. Further, as illustrated in FIG. 7B and FIG. 7C, at the tip of the electrical cable 90, the outer conductor 93 and a member for electrically connecting the outer conductor 93 are sandwiched along the Z-axis orientation by the bottom wall 31b and the above-described the cable support 31f, and the outer conductor 93 portion and the shell 31 are electrically connected. As illustrated in FIG. 7A, FIG. 7B, and FIG. 7C, the bottom wall 31b is in contact with the upper surface of the extending portion 11e of the receptacle connector 10 in a state where the plug connector 30 and the receptacle connector 10 are fitted to each other.

The side walls 31c are provided so as to extend downward (in a direction in which the ridge W protrudes) from both ends of the upper wall 31a in the Y-axis orientation. The pair of side walls 31c are provided so as to face each other. As illustrated in FIG. 6A, the inner surface (the surface facing the housing 12) of the pair of side walls 31c is provided with a ridge 31s extending horizontally (in the X-axis orientation). The ridge 31s may function as an mating portion used for engaging with the shell 11 of the receptacle connector 10. This point will be described later.

As illustrated in FIG. 6A and FIG. 7A, the front wall 31d is provided so as to extend downward (in the direction in which the ridge W projects) from one end of the upper wall 31a in the X-axis orientation. The front wall 31d is provided so as to overlap with the side wall 11b of the shell 11 of the receptacle connector 10 in a state where the plug connector 30 and the receptacle connector 10 are fitted.

As illustrated in FIG. 7B and FIG. 7C, the plurality of contacts 33 are constituted by, for example, metallic plate-shaped members subjected to press working, and have conductivity. The plurality of contacts 33 are arranged along the Y-axis orientation. As illustrated in FIGS. 7B and 7C, each the contact 33 extends along the X-axis orientation, and includes a connecting portion 33a, an intermediate portion 33b, and a contacting portion 33c. The first contact 33A and the second contact 33B are partially different from each other in shape, and are different from each other in attachment position in the plug connector 30. Accordingly, the first contact 33A and the second contact 33B will be individually described below also with regards to the attachment position.

As illustrated in FIG. 7C, the connecting portion 33a of the first contact 33A extends along the inner conductor 91 at the tip of the electrical cable 90 inside the housing 32, and the inner conductor 91 that is exposed is connected with solder M. The intermediate portion 33b in the first contact 33A connects the connecting portion 33a and the contacting portion 33c. The contacting portion 33c of the first contact 33A extends along the tip portion 32b of the housing 32 and is exposed on one side of the housing 32. The contacting portion 33c is in contact with the first contact 13A of the receptacle connector 10 in the receptacle connector 10 and the plug connector 30 fit. The contacting portion 33c may be formed with a recess 33d to ensure secure contact with the first contact 13A.

As illustrated in FIG. 7B, the connecting portion 33a of the second contact 33B extends along the inner conductor 91 at the tip of the electrical cable 90 inside the housing 32, and the inner conductor 91 that is exposed is connected with the solder M. The intermediate portion 33b in the second contact 33B connects the connecting portion 33a and the contacting portion 33c. The contacting portion 33c of the second contact 33B extends along the tip portion 32b of the housing 32 and is exposed on the side of the tip portion 32b opposite the side facing the electrical cable 90. The contacting portion 33c is in contact with the second contact 13B of the receptacle connector 10 in a state where the receptacle connector 10 and the plug connector 30 are fitted. The contacting portion 33c may be formed with the recess 33d to ensure secure contact with the second contact 13B.

As illustrated in FIG. 6A, FIG. 6B, etc., the first contacts 33A and the second contacts 33B are alternately arranged along the Y-axis orientation. Further, the first contacts 33A and the second contacts 33B are arranged in a row along the Y-axis orientation.

### Fitting State

The fitting state of the receptacle connector 10 and the plug connector 30 will be described with reference to FIG. 7A, FIG. 7B, and FIG. 7C. While the plug connector 30 is fitted to the receptacle connector 10, as illustrated in FIG. 7B and FIG. 7C, the ridge W of the plug connector 30 is accommodated in the groove portion 12c of the receptacle connector 10.

In the fitting state, as illustrated in FIG. 7C, the contacting portion 13c of the first contact 13A of the receptacle connector 10 and the contacting portion 33c of the first contact 33A of the plug connector 30 are brought into contact with each other, whereby the first contacts 13A, 33A are electrically connected to each other. Further, as illustrated in FIG. 7B, the contact between the contacting portion 13c of the second contact 13B of the receptacle connector 10 and the contacting portion 33c of the second contact 33B of the plug connector 30 are brought into contact with each other, whereby the second contacts 13B, 33B are electrically connected to each other.

Further, as illustrated in FIG. 7A, the ground connection is made by the contact between the contacting protrusion 11j of the shell 11 of the receptacle connector 10 and the bottom wall 31b of the shell 31 of the plug connector 30. Because the contacting protrusion 11j projects above the extending portion 11e, the contacting protrusion 11j pushes the bottom wall 31b upward.

Further, in the fitting state, as illustrated in FIG. 7A, the ridge 31s provided on the pair of side walls 31c of the shell 31 of the plug connector 30 is engaged with the recess 11s provided on the pair of side walls 11d of the shell 11 of the receptacle connector 10. The recess 11s and the ridge 31s are engaged with each other by the ridge 31s of the plug connector 30 entering the recess 11s of the receptacle connector 10 when the plug connector 30 approaches the receptacle connector 10 along the Z-axis orientation. The recess 11s and the ridge 31s function as an engaging portion for maintaining engagement between the receptacle connector 10 and the plug connector 30.

As illustrated in FIG. 7A, an engaging position between the ridge 31s of the plug connector 30 and the recess 11s of the receptacle connector 10 when the side surface of the housing 12 of the receptacle connector 10, that is, the fitting state between the receptacle connector 10 and the plug connector 30 is viewed from the Y-axis orientation is referred to as P1. The engaging position P1 is an area where the ridge 31s enters the recess 11s. That is, the ridge 31s in the engaging position P1 is the mating portion, and the recess 11s in the engaging position P1 is the engaging portion.

At this time, as illustrated in FIG. 7A, FIG. 7B, and FIG. 7C, when viewed from the side of the housing 12 of the receptacle connector 10, the engaging position P1 is set between the side wall 11b of the shell 11 that functions as the first shield portion in the receptacle connector 10 and the contacting protrusion 11j provided in the extending portion 11e. The fact that the engaging position P1 is set closer to the side wall 11b of the shell 11 than the contacting protrusion 11j means that the engaging portion is set closer to the center of the receptacle connector 10.

Further, as illustrated in FIG. 7A, FIG. 7B, and FIG. 7C, it can be said that the engaging position P1 is set between the contacting portion 13c of the first contact 13A and the contacting portion 13c of the second contact 13B, and the contacting protrusion 11j from the side view of the housing 12 of the receptacle connector 10. Since the contacting protrusion 11j presses the upper plug connector 30, force in a direction in which the fitting is released, that is, in a direction in which the receptacle connector 10 and the plug connector 30 move away from each other, acts between the receptacle connector and the plug connector 30. The force in the direction in which the fitting is released can be a force for releasing the contact of the contacts 13, 33 in contacting portions 13c, 33c. On the other hand, since the engaging position P1 is set between the contacting portions 13c, 33c and the contacting protrusion 11j, the upward force generated at the contacting protrusion 11j does not affect the contacting portions 13c, 33c.

### Operation

According to the receptacle connector 10 included in the connector device 1, the connecting portion 13a (the first connecting portion) of the first contact 13A is covered by the side wall 11b of the shell 11 as the first shield portion. In addition, the periphery of the connecting portion 13a (second connecting portion) of the second contact 13B is covered by the extending portion 11e of the shell 11 as a second shield portion. Accordingly, generation of noise from the first connecting portion and the second connecting portion during signal transmission can be suppressed.

A configuration in which a plurality of first contacts are arranged on one side of the housing 12 and a plurality of second contacts are arranged on the other side of the housing 12 is known. However, in the connector having such a shape, a configuration for preventing noise during signal transmission is insufficient. On the other hand, by providing the shield for the connecting parts of both the first contacts 13A and the second contacts 13B as described above, the noise can be suppressed.

Further, the extending portion 11e of the shell 11 as the second shield portion may be provided with the shell connecting portion 11k electrically connected to the circuit board 70. With such a configuration, the electrical connection between the shell 11 and the circuit board 70 can be made more reliably, and the shielding property can be enhanced.

In addition, the extending portion Ile of the shell 11 serving as the second shield portion may include the contacting protrusion 11j configured to be in contact with the shell of the mate connector while fitting with the plug connector 30 serving as the mate connector. By providing the contacting protrusion 11j, the shell 11 and the shell 31 of the plug connector 30, which is a mate connector, can be connected more reliably, so that the shielding property at the time of fitting can be enhanced.

The shell 11 may be provided with, for example, the recess 11s serving as an engaging portion configured to engage with the plug connector 30 between the first shield portion (the side wall 11b) and the contacting protrusion 11j along the Y-axis orientation when viewed from the side of the housing 12. By providing the contacting protrusion 11j, contact between the shell 11 and the shell 31 can be ensured. On the other hand, force in the direction of fitting with the plug connector 30 acts due to this the contacting protrusion 11j. On the other hand, since the engaging portion is provided, the fitting state with the plug connector 30 can be maintained.

The first contact 13A of the receptacle connector 10 includes the contacting portion 13c (first contacting portion) configured to contact the contact 33 of the plug connector 30. The second contact 13B also includes the contacting portion 13c (second contacting portion). The recess 11s as the engaging portion may be provided between the first contacting portion and the second contacting portion, and the contacting protrusion 11j when viewed from the side of the housing. By setting the position of the engaging portion between the first contacting portion and the second contacting portion, and the contacting protrusion as described above, the contacts with the plug connector 30 may be prevented from being affected by the forces in the direction of fitting with the plug connector 30, which are generated by providing the contacting protrusion 11j.

Even in the connector device 1 consisting of the receptacle connector 10 and the plug connector 30 as described above, generation of noise from the first connecting portion and the second connecting portion during signal transmission may be suppressed by the two shield portions as described above. In addition, since the shell 31 of the plug connector 30 is in contact with the extending portion 11e as the second shield portion, the shell 31 also functions as a shield. Accordingly, the generation of noise from the first connecting portion and the second connecting portion during signal transmission may be suppressed.

Further, in a case where the shell 11 of the receptacle connector 10 includes an engaging portion, the shell 31 of the plug connector 30 may include an mating portion configured to engage with the engaging portion. The engaging portion may be the recess 11s of the shell 11 and the mating portion is the ridge 31s of the shell 31. With such a configuration, the fitting state between the receptacle connector 10 and the plug connector 30 can be maintained more firmly.

The ridge 31s serving as the mating portion may be provided on each of a pair of side walls 31c of the shell 31 that are arranged to face each other in the orientation in which the plurality of contacts 33 of the plug connector 30 are arranged. By providing the engaging portion on both of the pair of opposing side surfaces, the fitting state between the receptacle connector 10 and the plug connector 30 can be maintained more firmly.

The shell 11 of the receptacle connector 10 surrounds the housing 12 and the connecting portion 13a of the first contact 13A around a first orientation perpendicular to the circuit board 70. The housing 32 of the plug connector 30 is configured to fit to the housing 12 of the receptacle connector 10. The shell 31 of the plug connector 30 includes a fitting portion (the front wall 31d) configured to fit to the shell 11, and a surrounding portion (the upper wall 31a, the bottom wall 31b, and the side wall 31c) surrounding the end portion of the electrical cable 90 around a second orientation parallel to the circuit board 70 at a position adjacent to the housing 12 along the second orientation and connected to the outer conductor 93 of the electrical cable 90. The shell 11 includes the extending portion 11e extending along the circuit board 70, configured to be located between the circuit board 70 and the surrounding portion, connected to the circuit board 70, and configured to be in contact with the surrounding portion.

With the configuration in which the surrounding portion is disposed at a position adjacent to the housing 12 along the second orientation, the height of the connector device 1 can be reduced. However, the surrounding portion may protrude like an antenna along the second orientation and become a noise source. On the other hand, since the extending portion 11e is connected to the circuit board 70 and is further in contact with the surrounding portion, the potential of the surrounding portion is stabilized. Accordingly, the possibility that the surrounding portion becomes a noise source can be reduced. Therefore, both the reduction in height of the connector device 1 and the suppression of noise may be achieved. Even in a configuration in which the second contacts 13B of the receptacle connector 10 are omitted and the second contacts 33B of the plug connector 30 are omitted, both the reduction in height of the connector device 1 and the suppression of noise may be achieved by the extending portion 11e.

The shapes and the like of the engaging portion and the mating portion may be modified. Further, the positional relationship between the contacts 13 and the contacts 33 may be changed.

Further, in the above, the case where the side wall 11b of the shell 11 constituting the first shield portion and the extending portion 11e of the shell 11 constituting the second shield portion are both configured integrally with the other portions of the shell 11 is described. However, the first shield portion and the second shield portion may be separate from other portions of the shell 11.

Further, in the above, the contacting protrusion 11j is formed by projecting a part of the coupling portion 11i upward. However, the contacting protrusion 11j may be a part of the coupling portion 11i.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A connector configured to be mounted on a circuit board and to fit to a mate connector, the connector comprising:
an insulating housing configured to face the circuit board;
a conductive first contact comprising a first connecting portion extending from the housing toward one direction along a parallel orientation, the parallel orientation being parallel to the circuit board while the connector being mounted on the circuit board, the first contact configured to be electrically connected to the circuit board;
a conductive second contact comprising a second connecting portion extending from the housing toward an opposite direction of the one direction, the second contact configured to be electrically connected to the circuit board; and
a conductive shell covering at least a part of the housing and configured to fit to the mate connector along a perpendicular orientation, the perpendicular orientation being perpendicular to the circuit board while the connector being mounted on the circuit board,
wherein the shell comprises:
a first shield portion surrounding the first connecting portion when viewed from the perpendicular orientation; and
a second shield portion surrounding the second connecting portion when viewed from the perpendicular orientation.

2. The connector according to claim 1, wherein the second shield portion comprises a shell connecting portion configured to be in contact with a conductor of the circuit board while the connector is mounted on the circuit board.

3. The connector according to claim 1, wherein the mate connector comprises:
a conductive mate first contact configured to be in contact with the first contact;
a conductive mate second contact configured to be in contact with the second contact; and
a conductive mate shell at least partially surrounding the mate first contact and the mate second contact,
wherein the first contact comprises a first contacting portion configured to be in contact with the mate first contact,
wherein the second contact comprises a second contacting portion configured to be in contact with the mate second contact,
wherein the first shield portion surrounds the first contacting portion, the second contacting portion, and the first connecting portion, when viewed from the perpendicular orientation,
wherein the first shield portion is configured to fit to the mate shell along the perpendicular orientation, and
wherein the second shield portion is configured to be located between the mate shell and the circuit board while the first shield portion fits to the mate shell.

4. The connector according to claim 3, wherein the second shield portion comprises a contacting protrusion configured to be in contact with the mate shell while the first shield portion fits to the mate shell.

5. The connector according to claim 4, wherein the first shield portion comprises a first side wall that faces the first connecting portion from the one direction,
wherein the shell comprises an engaging portion configured to engage with the mate connector, and
wherein the engaging portion is located between the first side wall and the contacting protrusion in the parallel orientation.

6. The connector according to claim 4, wherein the shell comprises an engaging portion configured to engage with the mate connector,
wherein the engaging portion is located between the first contacting portion and the contacting protrusion in the parallel orientation, and
wherein the engaging portion is located between the second contacting portion and the contacting protrusion in the parallel orientation.

7. The connector according to claim 6, wherein the first contacting portion is configured to contact the mate first contact from the one direction, and
wherein the second contacting portion is configured to contact the mate second contact from the opposite direction.

8. The connector according to claim 3, wherein each of the first shield portion and the second shield portion has a thickness orientation that is an orientation of smallest dimension thereof,
wherein the thickness orientation of the first shield portion is parallel to the circuit board while the connector is mounted on the circuit board, and
wherein the thickness orientation of the second shield portion is perpendicular to the circuit board while the connector is mounted on the circuit board.

9. The connector according to claim 8, wherein the first shield portion comprises a first side wall and a second side wall and the first contact is located between the first side wall and the second side wall in the parallel orientation, and
wherein the second shield portion is bent relative to the second side wall.

10. A connector device comprising the connector and the mate connector according to claim 3 wherein the mate shell is configured to be in contact with the second shield portion while the mate shell fits to the first shield portion.

11. The connector device according to claim 10, wherein the shell comprises an engaging portion configured to engage with the mate connector, and
wherein the mate shell comprises a mating portion configured to engage with the engaging portion.

12. The connector device according to claim 11, wherein the first contact and the second contact are arranged along an arrangement orientation that is perpendicular to both the perpendicular orientation and the parallel orientation,
wherein the mate shell comprises a pair of side surfaces configured to face each other in the arrangement orientation, and
wherein the mating portion is provided on each of the pair of side surfaces.

13. A connector configured to be mounted on a circuit board and to fit to a mate connector, the connector comprising:
an insulating housing configured to face the circuit board while the connector is mounted on the circuit board;
a conductive contact comprising a connecting portion extending from the housing toward one direction along a parallel orientation, the parallel orientation being parallel to the circuit board while the connector being mounted on the circuit board, the contact configured to be electrically connected to the circuit board; and
a conductive shell surrounding the housing and the connecting portion around a perpendicular orientation, the perpendicular orientation being perpendicular to the circuit board while the connector being mouted on the circuit board,
wherein the mate connector comprises:
an insulating mate housing configured to fit to the housing;
a conductive mate contact held by the mate housing, the mate contact configured to be connected to an inner conductor of a cable, and to be in contact with the contact; and
a conductive mate shell covering at least a part of the mate housing,
wherein the mate shell includes:
a mate fitting portion configured to fit to the shell along the perpendicular orientation; and
a surrounding portion adjacent to the mate fitting portion along the parallel orientation, the surrounding portion configured to surround an end portion of the cable around the parallel orientation to be electrically connected to an outer conductor of the cable,
wherein the shell comprises:
a fitting portion configured to fit to the mate fitting portion;
an extending portion extending from the fitting portion toward the one direction to be extending along the circuit board and located between the circuit board and the surrounding portion, the extending portion configured to be electrically connected to the circuit board, and
wherein the extending portion is further configured to be in contact with the surrounding portion while the mate fitting portion fits to the fitting portion.

14. The connector according to claim 13, wherein the extending portion comprises a shell connecting portion configured to be in contact with a conductor of the circuit board while the connector is mounted on the circuit board.

15. The connector according to claim 13, wherein the extending portion comprises a contacting protrusion configured to be in contact with the surrounding portion while the mate fitting portion fits to the fitting portion.

16. The connector according to claim 15, wherein the shell comprises a first side wall that faces the connecting portion from the one direction,
wherein the shell comprises an engaging portion configured to engage with the mate connector, and
wherein the engaging portion is located between the first side wall and the contacting protrusion in the parallel orientation.

17. The connector according to claim 15, wherein the contact comprises a contacting portion configured to be in contact with the mate contact, and
wherein the shell comprises an engaging portion configured to engage with the mate connector,
wherein the engaging portion is located between the contacting portion and the contacting protrusion.

18. The connector according to claim 13, wherein each of the fitting portion and the extending portion has a thickness orientation that is an orientation of smallest dimension thereof,
wherein the thickness orientation of the fitting portion is parallel to the circuit board while the connector is mounted on the circuit board, and
wherein the thickness orientation of the extending portion is perpendicular to the circuit board while the connector is mounted on the circuit board.

19. The connector according to claim 18, wherein the fitting portion comprises a first side wall and a second side wall and the contact is located between the first side wall and the second side wall in the parallel orientation, and
wherein the extending portion is bent relative to the second side wall.

20. A connector device comprising the connector and the mate connector according to claim 13.
